(19) United States
(12) Patent Application Publication
(10) Pub. No.: US 2013/0337118 A1
(43) Pub. Date: Dec. 19, 2013

(54) HEAT MOISTURE TREATED AND THERMALLY INHIBITED STARCHES AND FLOURS THAT IMPROVE THE CRISPNESS OF BATTERED AND BREADED FOODS

(71) Applicants: Callen Sistrunk, Sparta, NJ (US); Himanshu Shah, Branchburg, NJ (US); Tarak Shah, Raritan, NJ (US)

(72) Inventors: Callen Sistrunk, Sparta, NJ (US); Himanshu Shah, Branchburg, NJ (US); Tarak Shah, Raritan, NJ (US)

(73) Assignee: CORN PRODUCTS DEVELOPMENT, INC., Bridgewater, NJ (US)

(21) Appl. No.: 13/542,162

(22) Filed: Jul. 5, 2012

Related U.S. Application Data
(60) Provisional application No. 61/659,025, filed on Jun. 13, 2012.

(51) Int. Cl. A21D 10/04; A23L 1/217

(52) U.S. Cl. 426/95; 426/555; 426/550; 426/549; 426/94

(57) ABSTRACT

The application relates to a composition comprising separately by weight from about 20% to about 70% of non-gelatinized starch, from about 5% to about 40% of rice flour, from about 5% to about 30% of high amylose corn starch, and from about 5% to about 40% of heat moisture treated or thermally inhibited flour or starch.

The incorporation of low levels of tapioca dextrins into starch enrobing slurries is known in a variety of forms including as pure compositions (Crisp Coat®, National Starch) and as blends with high amylose starches (Crisp Coat UC® and Crisp Coat SC®, National Starch). The crispness of the enrobed food after frying is determined by several factors including the cook-out of the starch and/or flour, the moisture balance between the starch and/or flour solution surface and inside of the food, the thickness of the coating layer, and the interaction of ingredients in the enrobing slurry. The coating forms a discontinuous film which lets the moisture from the inside of the food escape or vent out, but will not absorb significant amounts of moisture into the coating layer. There is a trend in the food industry to provide “all natural” battered and breaded foods. In order to achieve this objective, chemically modified starch and dextrin may not be used. Chemically modified starches can be replaced by thermally modified alternatives. However, no effective alternative had been found in the past to replace the dextrin in fry coatings to provide an enhanced crisping effect.

Woerman et al. in U.S. Pat. No. 5,750,168 issued May 12, 1998 teach aqueous starch enrobing slurries comprising not less than 30% by weight ungelatinized cross-linked tapioca starch, a rice flour component at a solids concentration of from about 10% to about 25% by weight, and which is substantially free of corn starch. Thomas et al. in U.S. Pat. No. 6,221,420 B1, issued Apr. 24, 2001 show a thermally inhibited, waxy maize starch and thermally inhibited, waxy rice flour in a 25% fat salad dressing. Wong et al. in U.S. Pat. No. 7,223,433 B2 issued May 29, 2007 teach a flour/starch blend for preparing stuffed rolls wrappers comprising from 48% to 52% of high amylose rice starch, from 31% to 36% of high amylose rice flour, from 8% to 12% of potato starch, from 4% to 7% of modified tapioca starch, and from 0.2 to 2% of pregelatinized wheat flour.

Rogels et al. in Patent Application Publication No. US 2001/0004463 A1, dated Jun. 21, 2001 describe a fry coating composition comprising ungelatinized starch and not less than 50% of rice flour. Scavone et al. in Patent Application Publication No. US 2001/0055637 A1, dated Dec. 27, 2001 describe a coating for potato strips comprising cross-linked potato starch (39.245 wt %), high amylose corn starch (30.83 wt %), tapioca dextrin (13.215 wt %), and rice flour (15.0 wt %). Brown et al. in Patent Application Publication No. US 2006/0025382 A1, dated Feb. 2, 2006 teach an extruded breakfast cereal containing 43% modified maize starch, 11.5% rice flour, 11.5% oat flour, and 20.4% wheat flour. Villagran et al. in Patent Application Publication No. US 2006/0286271 A1, dated Dec. 21, 2006, teach a rice flour composition having from about 20% to about 95%, by weight, of a rice flour and from about 5% to about 80%, by weight, of rice starch material. DeStafeno in Patent Application Publication No. US 2009/0181147 A1, dated Jul. 16, 2009, teaches a dry mix for gluten-free baked goods comprised of approximately ½ part rice flour, ⅛ part tapioca starch, and ⅛ part corn starch. Foo et al. in Patent Application Publication No. US 2011/0151094 A1, dated Jun. 23, 2011, teach a rice-based food product having a reduced GI value comprising mixing rice flour and tapioca starch to form a dry mix.

### SUMMARY

In one aspect, the application provides a composition comprising separately by weight:

a) from about 20% to about 70% of non-gelatinized starch,

b) from about 5% to about 40% of rice flour,

c) from about 5% to about 30% of high amylose corn starch, and

d) from about 5% to about 40% of flour or starch, which has been heat moisture treated or thermally inhibited.

### DETAILED DESCRIPTION

In one aspect, the application provides a composition comprising separately by weight:

a) from about 20% to about 70% of non-gelatinized starch,

b) from about 5% to about 40% of rice flour,

c) from about 5% to about 30% of high amylose corn starch, and

d) from about 5% to about 40% of flour or starch, which has been heat moisture treated or thermally inhibited.

In one embodiment, the amount by weight of non-gelatinized starch is from about 30% to about 50%.

In one embodiment, the amount by weight of non-gelatinized starch is from about 35% to about 40%.

In one embodiment, the amount by weight of rice flour is from about 15% to about 30%.

In one embodiment, the amount by weight of rice flour is from about 18% to about 24%.

In one embodiment, the amount by weight of high amylose corn starch is from about 9% to about 24%.

In one embodiment, the amount by weight of high amylose corn starch is from about 12% to about 17%.

In one embodiment, the amount by weight of flour or starch, which has been heat moisture treated or thermally inhibited is from about 10% to about 35%.

In one embodiment, the amount by weight of flour or starch, which has been heat moisture treated or thermally inhibited is from about 20% to about 25%.

In one embodiment, the amount by weight of non-gelatinized starch is from about 35% to about 40%, the amount by weight of rice flour is from about 18% to about 24%, the amount by weight of high amylose corn starch is from about 12% to about 17%, and the amount by weight of flour or starch, which has been heat moisture treated or thermally inhibited is from about 20% to about 25%.

In one embodiment, the non-gelatinized starch is potato starch, corn starch, tapioca starch, or any mixtures thereof.

In one embodiment, the inhibited flour or starch is heat moisture treated.

In one embodiment, the heat moisture treated flour or starch is heat moisture treated rice flour, heat moisture treated waxy rice starch, heat moisture treated sorghum flour, heat moisture treated waxy wheat flour, or any mixtures thereof.

In one embodiment, the inhibited flour or starch is thermally inhibited.

In one embodiment, the thermally inhibited flour or starch is thermally inhibited rice flour, thermally inhibited waxy rice starch, thermally inhibited sorghum flour, thermally inhibited waxy wheat flour, or any mixtures thereof.

In one aspect, the application provides an enrobing solution comprising one part by weight of a composition comprising separately by weight:

a) from about 20% to about 70% of non-gelatinized starch,

b) from about 5% to about 40% of rice flour,

c) from about 5% to about 30% of high amylose corn starch, and

d) from about 5% to about 40% of flour or starch, which has been heat moisture treated or thermally inhibited; and

from about one part to about two parts by weight of water.

In one embodiment, the enrobing solution comprises from about 1.2 parts to about 1.6 parts by weight of water.

In one aspect, the application provides an enrobed food prepared with an enrobing solution comprising one part by weight of a composition comprising separately by weight:

a) from about 20% to about 70% of non-gelatinized starch,

b) from about 5% to about 40% of rice flour,

c) from about 5% to about 30% of high amylose corn starch, and

d) from about 5% to about 40% of flour or starch, which has been heat moisture treated or thermally inhibited; and

from about one part to about two parts by weight of water.

In one embodiment, the enrobed food comprises potato.

In one embodiment, the enrobed food comprises sweet potato.

In one embodiment, the enrobed food is then par fried.

In one embodiment, the enrobed food is then frozen.

In one embodiment, the enrobed food is then baked.

In one embodiment, the enrobed food is then, in any sequence, par fried, frozen, and baked.

The present application provides improved aqueous coatings which provide improved crispness and other physical properties to coated food products such as sweet potato fries in the absence of a dextrin component. As one aspect of the present application, coatings have been found that provide various improved properties to the resulting sweet potato fries which they are used to coat. Specifically it has been found that unexpected crispness can be obtained in sweet potato fry coating compositions without dextrin by using aqueous coating having an as-is solids content comprising ungelatinized starch, native rice flour, high amylose starch and not less than 10% flour or starch, which has been heat moisture treated or thermally inhibited. In another embodiment, the coating comprises not less than 20% flour or starch, which has been heat moisture treated or thermally inhibited. In another embodiment the coating comprises not less than 25% flour or starch, which has been heat moisture treated or thermally inhibited. In one embodiment, the flour or starch, which has been heat moisture treated or thermally inhibited is rice flour, waxy rice starch, sorghum flour, or waxy wheat flour. It has been found that the use of such coatings comprising elevated levels of flour or starch, which has been heat moisture treated or thermally inhibited (rice flour, waxy rice starch, sorghum flour, or waxy wheat flour) in combination with ungelatinized starches, native rice flour, and high amylose starch provides surprisingly improved crispness to the coated sweet potato fries. The ungelatinized starch may be selected from any of the wide variety of starches known to the art including physically modified and unmodified starches including potato starch, corn starch, or tapioca starch. In one embodiment of the application, tapioca starch is the ungelatinized starch.

This application provides a coating which provides improved crispness and other physical properties to food pieces such as meat, poultry, fish, and vegetables. One aspect of the present application is to improve the crispiness of the French fry coating. It has been found that improved crispness can be obtained in a sweet potato fry coating having an as-is solids content containing ungelatinized starch, native rice flour, high amylose starch, and not less than 10% of flour or starch, which has been heat moisture treated or thermally inhibited. In one embodiment, about 20% flour or starch, which has been heat moisture treated or thermally inhibited is used. In another embodiment, about 40% flour or starch, which has been heat moisture treated or thermally inhibited from one of the following sources: rice flour, waxy rice starch, sorghum flour, or waxy wheat flour is used.

This coating contains ungelatinized starches from one of the following sources potato, corn, or tapioca; native rice flour; high amylose starch; flour or starch, which has been heat moisture treated or thermally inhibited from one of the following sources (rice flour, waxy rice starch, sorghum flour, or waxy wheat flour); salt; leavening; dextrose; and xanthan gum.

The application further provides processes for preparing a frozen sweet potato product with a film-like coating on the outer surface and the products so produced, which comprises cutting the raw sweet potatoes; blanching the sweet potatoes; partially drying the sweet potatoes; coating the sweet potatoes with the aqueous enrobing solutions of the application; followed by par frying the sweet potatoes in hot oil; and freezing the sweet potatoes.

The application further provides a dry coating mix for coating the outer surface of a sweet potato product having an as-is solids content comprising ungelatinized starch, native rice flour, high amylose starch and in one embodiment not less than 10% flour or starch, which has been heat moisture treated or thermally inhibited. In another embodiment, the dry coating comprises not less than 20% flour or starch, which has been heat moisture treated or thermally inhibited. In another embodiment the dry coating comprises not less than 25% flour or starch, which has been heat moisture treated or thermally inhibited. In one embodiment, the heat moisture treated or thermally inhibited flour or starch is rice flour, waxy rice starch, sorghum flour, or waxy wheat flour. The application further provides methods of producing such a dry coating mix comprising blending ungelatinized starch, native rice flour, high amylose starch, and in one embodiment not less than 10% flour or starch, which has been heat moisture treated or thermally inhibited. In another embodiment, the method comprises blending not less than 20% flour or starch, which has been heat moisture treated or thermally inhibited. In another embodiment, the method comprises blending not less than 25% flour or starch, which has been heat moisture treated or thermally inhibited. In one embodiment, the flour or starch, which has been heat moisture treated or thermally inhibited is rice flour, waxy rice starch, sorghum flour, or waxy wheat flour.

Preliminary screening of numerous compositions revealed that several starches or flours, which were heat moisture treated or thermally inhibited, were acceptable to create a dextrin free coating with similar or better crispiness as compared to compositions, which contain dextrin. Specifically, there were several starch or flour compositions without dextrin that worked in aqueous starch enrobing solutions with similar or better crispness:

1) a commercially available, heat moisture treated, rice flour;

2) a commercially available, thermally inhibited, waxy rice starch;

3) a commercially available, heat moisture treated, waxy wheat flour;

4) thermally inhibited waxy wheat flour; and

5) thermally inhibited sorghum flour.

A commercially available, heat moisture treated, rice flour was investigated in detail. The other heat moisture treated and thermally inhibited starches and flours were also tested but to a lesser extent.

Processes for the production of frozen sweet potato fries are well known and include the basic steps of preparing raw potatoes by washing, peeling, and cutting into appropriately shaped pieces. The resulting potato strips are then blanched according to conventional methods in order to inactivate enzymes in the potato and to leach sugars from the surface of the sweet potato strip. In one embodiment, the blanched sweet potato strips are treated in a brine solution containing about 0.75% sodium acid pyrophosphate (SAPP). After these steps, the sweet potato strips are then subjected to a drying step to reduce the moisture present in the strips.

The strips are then coated with the aqueous enrobing solution of the application comprising ungelatinized starch, native rice flour, high amylose starch, and not less than 10% flour or starch, which has been heat moisture treated or thermally inhibited. In one embodiment, rice flour, waxy rice starch, sorghum flour, or waxy wheat flour are used as the heat moisture treated or thermally inhibited starch or flour. In one embodiment, about 20% of flour or starch, which has been heat moisture treated or thermally inhibited is used. In one embodiment, about 40% of flour or starch, which has been heat moisture treated or thermally inhibited is used. After blending of the solid ingredients with a desired amount of water to produce the sweet potato fry enrobing solution, the enrobing solution may be applied to coat the cut potato strips with a coating pickup of from about 8% to about 30%. In one embodiment, the coating pickup is from about 12% to about 18%. In one embodiment, the coating pickup is about 15%, (based on coated sweet potato strips weight).

After coating with the aqueous enrobing solution, the sweet potato strips are drained and par fried at a temperature of from about 182° C. to about 199° C. for a time period from about 40 seconds to about 90 seconds. Par frying serves to gelatinize the starch of the sweet potato strips and of the coating and removes moisture from the inside of the sweet potato strip.

The sweet potato strips are then frozen, packaged, and in one embodiment stored at a temperature below −18° C. until they are prepared for final consumption. In order to prepare the potato strips for consumption, they are cooked either by frying or by baking in an oven. After such preparation, sweet potato strips prepared according to the application are characterized by a crisp outer layer and a moist tender interior.

A variety of other flours and starches may optionally be used in producing the coating compositions of the application including, but not limited to, potato starch, potato flour, sago starch, sago flour, wheat starch, oat flour, oat starch, corn flour, or corn starch. Such starches may be cross-linked and/or substituted such as by acetylation or other means.

Optional ingredients for use in providing the coating compositions of the application include maltodextrins, microcrystalline cellulose, hydrocolloids, gums including xanthan gum or guar gum, or the like which are used to provide improved structure and keeping qualities to the coated sweet potato products. Maltodextrins are used in one embodiment at solids concentrations of up to 6%. Maltodextrins useful with the application may be derived from any type of starch including tapioca, potato, or corn starch and include those characterized by having a DE in the range from 2 to 7. In one embodiment, the maltodextrins has a DE of about 5. In one embodiment, gum blends are incorporated into the compositions of the application at solids concentrations of less than 0.15% gum by weight.

Leavening agents in the form of baking powders may also be incorporated into the compositions of the application in order to open up the structure of the coating batters upon cooking and release moisture from the French fry products without blowing off the coating layer. Suitable baking powders include sodium bicarbonate plus one or more leavening acids such as sodium aluminum phosphate (SALP), sodium aluminum sulfate (SAS), sodium acid pyrophosphate (SAPP), dicalcium phosphate (DCP), or anhydrous monocalcium phosphate (AMCP). The combination of sodium bicarbonate and SAPP is one embodiment. Such leavening agents are, in one embodiment, added at sodium bicarbonate concentrations from about 0.9 parts soda to about 1.1 parts SAPP.

The compositions of the application may include protein components such as sodium caseinate, nonfat dry milk, soy, whey, or dried egg whites. Such proteins interact with the carbohydrates in the coating compositions to increase film strength, provide structure, improve crispness, and prolong holding of crispness. The compositions of the application may include carbohydrate components such as microcrystalline cellulose or the like. Still other optional ingredients may also be incorporated into the coating compositions of the application including salt, flavorings, seasonings, or browning agents such as whey or dextrose.

In one embodiment, the sweet potato fry aqueous enrobing solution is prepared by dry blending of the various solid ingredients. Water is then slowly added to the dry ingredients in an amount selected to provide an appropriate viscosity to the coating batter. In one embodiment, aqueous slurries containing from about 1.2 parts to about 1.6 parts by weight of water to 1 part by weight of the solid ingredients have a satisfactory viscosity for coating the potato strips. The ungelatinized starches do not substantially contribute to the viscosity of the solution. In another embodiment, the sweet potato fry aqueous enrobing solution is prepared by adding a dry blend of the various solid ingredients to water. In another embodiment, the sweet potato fry aqueous enrobing solution is prepared by adding the various solid ingredients, either one at a time or in combinations, to water.

Controlling moisture migration is important to maintaining the crispness of the sweet potato fries during holding prior to consumption. The coating may, in one embodiment, be somewhat brittle, which gives a clean bite with minimum toughness. There is a fine balance between all the ingredients in the coating formula to achieve crispness and keeping quality with the method used to process the sweet potato strips contributing to the crispness of the sweet potato fries. It is further contemplated that the improved properties provided by the solids making up the enrobing solutions of the application may also be provided when the solids ingredients making up the solutions are applied to sweet potato products in a non-aqueous solution form such as by dusting.

### DEFINITIONS

The following definitions are used in connection with the compounds of the present application unless the context indicates otherwise. Enrobed food is food coated or encased or sealed by something. The acronym DE means dextrose equivalent. The phrase “as-is solids content” refers to a solids content for a composition assuming a water concentration in the starch or flour components of about 12% by weight.

As used herein, the term “dextrin” means the products made by heating dry starch with or without acid. During the reaction, greater or lesser amounts of hydrolysis; transglycosidation, and repolymerization occur. According to which reaction predominates, the product is a white dextrin, a yellow dextrin, or a British gum.

As used herein, the term “dextrin-free” means less than about 0.1% dextrin, less than about 0.05% dextrin, less than about 0.01% dextrin, or essentially 0% dextrin.

As used herein, the phrase “heat moisture treatment” means a process in which a subject is heated by using, as a heating medium, saturated steam or hot water in a high-humidity atmosphere, for example, an atmosphere of at least 60% humidity. The subject to be heated may be brought into direct contact with the heating medium or the subject may be brought into indirect contact with the heating medium like an indirect heating system, for example, in an atmosphere of at least 60% humidity may be performed. The heat moisture treatment of native starch causes an irreversible modification of the semi-crystalline structure, which changes from an ordered state to a disordered state, resulting in gelatinization. The gel thus formed is not stable and after a few days the starch restructures itself into a more ordered structure, this phenomenon being known as retrogradation. The physical characteristics of starches are modified by heat moisture treatment without change in their granular appearance. These changed characteristics include change in equilibrium moisture content, change in X-ray diffraction pattern, change in the swelling power of starch granules, and increase in the gelatinization temperature.

As used herein, the term “high amylose” includes a starch containing at least 40% amylose by weight. As used herein, the phrase, “comprising separately” means each of the following items must be included individually, no item can fill more than one of the roles, but the phrase does not exclude additional, unrecited elements.

As used herein, the phrase “hydrothermal treatments” refers to both annealing and heat moisture treatment. These modify the physicochemical properties of starch without destroying the granule structure. Both treatments involve incubation at certain moisture levels and temperatures above the glass transition temperature and below the gelatinization or melting temperature. Heat treatments at higher-moisture levels have been termed “annealing” (ANN) while treatments performed at lower-moisture levels have been termed “heat moisture treatments” (HMT).

As used herein, the phrase “inhibited flour or starch” means a flour or starch altered by physical or chemical treatment to give reduced gelatinization in hot water and/or greater stability to acids and alkalis.

As used herein, the phrase “non-gelatinized starch” means a starch that has not been gelatinized. Starch gelatinization is a process that breaks down the intermolecular bonds of starch molecules in the presence of water and heat. Gelatinization irreversibly dissolves the starch granule, increases the randomness of the general granule structure, and decreases the number and size of crystalline regions. As the gelatinization proceeds, the starch loses its birefringence and its Maltese cross.

As used herein, the phrase “rice flour” means the product obtained by finely grinding grains of rice. The rice flour may be made from short grain rice, medium grain rice, long grain rice, white rice, brown rice, or any mixtures thereof.

As used herein, the phrase “thermally inhibited starch or flour” means a starch or flour subjected to a heat treatment process that results in the starch or flour becoming and remaining inhibited. A starch or flour is referred to as “inhibited” or “thermally inhibited” if these thermally inhibited starches or flours when dispersed and/or cooked in water exhibit the textural and viscosity properties characteristic of a chemically-cross-linked starch or flour. The starch granules are more resistant to viscosity breakdown. This resistance to breakdown results in what is subjectively considered a non-cohesive or “short” textured paste, meaning that the gelatinized starch or flour tends to be salve-like and heavy in viscosity rather than runny or gummy. The non-pregelatinized thermally inhibited granular starches or flours exhibit an unchanged or reduced gelatinization temperature. In contrast, most annealed and heat/moisture treated starches or flours show an increased gelatinization temperature. Chemically cross-linked starch or flours show an unchanged gelatinization temperature. It is believed the overall granular structure of the thermally inhibited starches has been altered. The starches that are substantially completely thermally inhibited will resist gelatinization. The starches that are highly inhibited will gelatinize to a limited extent and show a continuing rise in viscosity but will not attain a peak viscosity. The starches that are moderately inhibited will exhibit a lower peak viscosity and a lower percentage breakdown in viscosity compared to the same starch that is not inhibited. The starches that are lightly inhibited will show a slight increase in peak viscosity and a lower percentage breakdown in viscosity compared to the same starch that is not inhibited. For non-pregelatinized thermally inhibited starches, the Brabender viscosity initializes (starts to build) at an earlier or substantially the same time as the same starch which has not been thermally inhibited. In addition, the thermally inhibited starches will have less viscosity breakdown than the same starch which has not been thermally inhibited.

Starch or flour inhibition may be characterized by Brabender curves. For a highly inhibited starch or flour, the Brabender curve will be flat, indicating that the starch or flour is so inhibited that it is resisting any further gelatinization or the curve will be a rising Brabender curve, indicating that further gelatinization is occurring at a slow rate and to a limited extent. For a less inhibited starch or flour, the Brabender curve will show a dropping curve, but the overall breakdown in viscosity from the peak viscosity will be lower than that for a non-inhibited starch or flour. Thermally inhibited starches and methods for making them are known and described in U.S. Pat. Nos. 5,725,676, 5,932,01, or 6,231,675.

### EXAMPLES

### Example 1

### Comparison of a Commercially Available, Heat Moisture Treated, Rice Flour, a Commercially Available, Thermally Inhibited, Tapioca Starch, and a Commercially Available, Thermally Inhibited, Waxy Rice Starch to Tapioca Dextrin in a Sweet Potato Product Coating

According to this example, dextrin was substituted in a standard sweet potato fry composition with a heat moisture treated rice flour, a thermally inhibited tapioca starch, or a thermally inhibited waxy rice starch. See the methodology and comparative sensory results below. Sweet potatoes were peeled, pre-heated in water for 30 minutes at 71° C., cut into ⅜ inch strips, and immersed and blanched in hot water for 3 minutes at 88° C. After blanching, the potato strips were immersed for 30 seconds in an aqueous solution comprising 0.75% SAPP which was held at a temperature of 71-77° C. After removal, the strips were drained and then dried in a conventional dryer at 60° C., for a sufficient length of time to produce a 10 to 14 percent water loss.

Enrobing solutions were then prepared comprising the ingredients listed in Table 1 including water. The dry ingredients were combined, added to water at a 1:1.4 ratio, and well mixed using a KitchenAid® mixer. The sweet potato strips were then dipped in the starch solution. The sweet potato strips were then drained to remove excess solution and to achieve a solution coating pickup about 12-18%, averaging 15%. The strips were then par fried in soybean oil for 60 seconds at 191° C. The sweet potato strips were transferred into plastic trays, frozen in a blast freezer at −29° C. for 1 hour minimum, and stored in a freezer for two weeks at −23° C. before being evaluated by sensory descriptive profiling. See Table 2 for results.

TABLE 1

| | 1A | 1B | 1C | 1D |
|---|---|---|---|---|
| Ingredient | (%) | (%) | (%) | (%) |
| a commercially available, | 53.00 | 53.00 | 53.00 | 53.00 |
| thermally inhibited tapioca starch | | | | |
| rice flour | 24.88 | 24.88 | 24.88 | 24.88 |
| an unmodified corn starch | 7.00 | 7.00 | 7.00 | 7.00 |
| containing about 55% amylose | | | | |
| salt | 3.00 | 3.00 | 3.00 | 3.00 |
| dextrose | 1.00 | 1.00 | 1.00 | 1.00 |
| sodium bicarbonate | 1.00 | 1.00 | 1.00 | 1.00 |
| xanthan gum | 0.12 | 0.12 | 0.12 | 0.12 |
| turmeric and oleoresin paprika | <0.10 | <0.10 | <0.10 | <0.10 |
| a commercially available tapioca | 10.00 | | | |
| dextrin | | | | |
| commercially available, heat | | 10.00 | | |
| moisture treated, rice flour | | | | |
| a commercially available, | | | 10.00 | |
| thermally inhibited tapioca starch | | | | |
| (same as above) | | | | |
| a commercially available, | | | | 10.00 |
| thermally inhibited, waxy rice | | | | |
| starch | | | | |
| total | 100.00 | 100.00 | 100.00 | 100.00 |

Frozen sweet potato fry samples were portioned out in batches prior to baking. Samples were baked on sheet pans for 22 minutes in pre-heated 204° C. ovens. Baked fries were immediately transferred to the panel room. Panelists evaluated the samples after ten-minute from removal from the ovens. Separate rounds of batches were prepared and served fresh during the panel session. Each panelist was asked to use 2-3 fries per attribute per sample to allow for variation in the products. Panelists were then asked to average the fries evaluated per attribute per sample and enter the averaged score as their response.

All products were evaluated for texture by panelists trained in Sensory Spectrum methodology of foods. Products were presented to the Descriptive Panel using a randomized design. The data was collected using Compusense software. Panelists rated the intensity of these texture attributes on a 15-point intensity scale using the references provided. Products were evaluated at ten minutes for the texture attributes listed below. The results are expressed in Table 2.

Hardness—Front Teeth

Crispness—1st Bite

Toughness

Uniformity of Bite

Hardness—Molars

Crispness—1st Chew

Crispness—45th Chews

Duration of Sound

TABLE 2

| Textural Attribute | 1A | 1B | 1C | 1D |
|---|---|---|---|---|
| Hardness - Front Teeth | 5.00 | 5.06 | 4.92 | 5.19 |
| Crispness - 1st Bite | 1.81 | 2.08 | 1.89 | 2.11 |
| Toughness | 3.81 | 3.58 | 3.86 | 3.97 |
| Uniformity of Bite | 8.33 | 9.08 | 9.13 | 9.08 |
| Hardness - Molars | 4.81 | 4.64 | 4.39 | 4.83 |
| Crispness - 1st Chew | 2.67 | 2.44 | 2.44 | 2.44 |
| Crispness - 4-5th Chews | 2.67 | 2.53 | 2.36 | 2.75 |
| Duration of Sound | 4.50 | 4.31 | 4.11 | 4.61 |

In terms of texture, all four products are quite similar in all textural attributes. The all natural, non-dextrin ingredients (the commercially available, heat moisture treated, rice flour, the commercially available, thermally inhibited, tapioca starch, and the commercially available, thermally inhibited, waxy rice starch) gave a more uniform bite at 10 minutes compared to tapioca dextrin control. In qualitative evaluation, sweet potato fries were similar in appearance and flavor. Textural differences revealed a large range in size and shape of the fries with thicker pieces being less crisp and thinner pieces being crisper. The results show that even in the absence of dextrin as a crisping agent that crispness was comparable between the samples. Such results are unexpected in the absence of a dextrin component to promote crispness. However, the commercially available, thermally inhibited tapioca starch was not as crisp after 4^{th}-5^{th} chews, therefore deemed not a direct replacement for dextrin. Based on experience in practice, thermally inhibited tapioca starch (considered a backbone starch) builds texture and body in coating solutions but does not individually create crispness. The commercially available, heat moisture treated, rice flour and commercially available thermally inhibited waxy rice starch were equivalent to dextrin in crispness.

### Example 2

### Evaluation of a Commercially Available, Heat Moisture Treated, Rice Flour Compared to Other Components on Crispness Attributes in a Sweet Potato Product Coating

Results of the experimentation conducted in Example 1 indicated that a commercially available, heat moisture treated, rice flour showed comparable textural results as compared to tapioca dextrin. A design of experiments (DOE) was carried out to evaluate the level of each starch or flour component in the composition, which included a commercially available, thermally inhibited, tapioca starch, native rice flour, an unmodified corn starch containing about 55% amylose, and a commercially available, heat moisture treated, rice flour. The commercially available, thermally inhibited, waxy rice starch was not evaluated in the design of experiments. Sweet potatoes were peeled, pre-heated in water for 30 minutes at 71° C., cut into ⅜ inch strips, and immersed and blanched in hot water for 3 minutes at 88° C. After blanching, the potato strips were immersed for 30 seconds in an aqueous solution comprising 0.75% SAPP which was held at a temperature of 71-77° C. After removal, the strips were drained and then dried in a conventional dryer at 60° C., for a sufficient length of time to produce a 10 to 14 percent water loss.

Enrobing solutions were then prepared comprising the ingredients listed in Table 3 including water. The dry ingredients were combined, added to the water at a 1:1.4 ratio, and well mixed using a KitchenAid® mixer. The sweet potato strips were then dipped in the starch solution. The sweet potato strips were then drained to remove excess solution and to achieve a solution coating pickup about 12-18%, averaging 15%. The strips were then par fried in soybean oil for 60 seconds at 191° C. The strips were then par fried in soybean oil for 60 seconds at 191° C. The sweet potato strips were transferred into plastic trays, frozen in a blast freezer at −29° C. for 1 hour minimum, and stored in a freezer for two weeks at −23° C. before being evaluated by sensory descriptive profiling as in Example 1. See Table 4 for results.

TABLE 3

| Ingredients | Control | 1B | 2B | 3B | 4B | 5B | 6B |
|---|---|---|---|---|---|---|---|
| a commercially available, | 53.00 | 57.00 | 66.50 | 38.00 | 38.00 | 66.50 | 57.00 |
| thermally inhibited, | | | | | | | |
| tapioca starch | | | | | | | |
| rice flour | 24.88 | 9.50 | 15.83 | 9.50 | 19.00 | 28.50 | 19.00 |
| an unmodified corn | 7.00 | 0.00 | 0.00 | 19.00 | 9.50 | 0.00 | 19.00 |
| starch containing about | | | | | | | |
| 55% amylose | | | | | | | |
| salt | 3.00 | 2.92 | 2.92 | 2.92 | 2.92 | 2.92 | 2.92 |
| dextrose | 1.00 | 0.98 | 0.98 | 0.98 | 0.98 | 0.98 | 0.98 |
| sodium bicarbonate | 1.00 | 0.98 | 0.98 | 0.98 | 0.98 | 0.98 | 0.98 |
| xanthan gum | 0.12 | 0.12 | 0.12 | 0.12 | 0.12 | 0.12 | 0.12 |
| turmeric and oleoresin | <0.10 | <0.10 | <0.10 | <0.10 | <0.10 | <0.10 | <0.10 |
| paprika | | | | | | | |
| tapioca dextrin | 10.00 | 0.00 | 0.00 | 0.00 | 0.00 | 0.00 | 0.00 |
| a commercially available, | 0.00 | 28.50 | 12.67 | 28.50 | 28.50 | 0.00 | 0.00 |
| heat moisture treated, rice | | | | | | | |
| flour | | | | | | | |
| total | 100.00 | 100.00 | 100.00 | 100.00 | 100.00 | 100.00 | 100.00 |
| Ingredients | 7B | 8B | 9B | 10B | 11B | 12B | 13B |
| a commercially available, | 38.00 | 66.50 | 38.00 | 57.00 | 38.00 | 57.00 | 66.50 |
| thermally inhibited, | | | | | | | |
| tapioca starch | | | | | | | |
| rice flour | 28.50 | 9.50 | 9.50 | 9.50 | 28.50 | 28.50 | 19.00 |
| an unmodified corn | 19.00 | 19.00 | 19.00 | 0.00 | 19.00 | 9.50 | 9.50 |
| starch containing about | | | | | | | |
| 55% amylose | | | | | | | |
| salt | 2.92 | 2.92 | 2.92 | 2.92 | 2.92 | 2.92 | 3.00 |
| dextrose | 0.98 | 0.98 | 0.98 | 0.98 | 0.98 | 0.98 | 1.00 |
| sodium bicarbonate | 0.98 | 0.98 | 0.98 | 0.98 | 0.98 | 0.98 | 1.00 |
| xanthan gum | 0.12 | 0.12 | 0.12 | 0.12 | 0.12 | 0.12 | 0.12 |
| turmeric and oleoresin | <0.10 | <0.10 | <0.10 | <0.10 | <0.10 | <0.10 | <0.10 |
| paprika | | | | | | | |
| tapioca dextrin | 0.00 | 0.00 | 0.00 | 0.00 | 0.00 | 0.00 | 0.00 |
| a commercially available, | 9.50 | | 28.50 | 28.50 | 9.50 | 0.00 | 0.00 |
| heat moisture treated, rice | | | | | | | |
| flour | | | | | | | |
| total | 100.00 | 100.00 | 100.00 | 100.00 | 100.00 | 100.00 | 100.00 |
| Ingredients | 14B | 15B | 16B | 17B | 18B | 19B | 20B |
| a commercially | 45.13 | 47.50 | 66.50 | 57.00 | 47.50 | 52.30 | 52.30 |
| available, thermally | | | | | | | |
| inhibited, tapioca starch | | | | | | | |
| rice flour | 19.00 | 28.50 | 9.50 | 9.50 | 19.00 | 23.70 | 23.70 |
| an unmodified corn | 14.25 | 0.00 | 19.00 | 9.50 | 0.00 | 7.00 | 7.00 |
| starch containing about | | | | | | | |
| 55% amylose | | | | | | | |
| salt | 2.92 | 2.92 | 2.92 | 2.92 | 2.92 | 2.92 | 2.92 |
| dextrose | 0.98 | 0.98 | 0.98 | 0.98 | 0.98 | 0.98 | 0.98 |
| sodium bicarbonate | 0.98 | 0.98 | 0.98 | 0.98 | 0.98 | 0.98 | 0.98 |
| xanthan gum | 0.12 | 0.12 | 0.12 | 0.12 | 0.12 | 0.12 | 0.12 |
| turmeric and oleoresin | <0.10 | <0.10 | <0.10 | <0.10 | <0.10 | <0.10 | <0.10 |
| paprika | | | | | | | |
| tapioca dextrin | 0.00 | 0.00 | 0.00 | 0.00 | 0.00 | 0.00 | 12.00 |
| a commercially | 16.62 | 19.00 | 0.00 | 19.00 | 28.50 | 12.00 | 0.00 |
| available, heat moisture | | | | | | | |
| treated, rice flour | | | | | | | |
| total | 100.00 | 100.00 | 100.00 | 100.00 | 100.00 | 100.00 | 100.00 |

TABLE 4

| | Con- | | | | | | |
|---|---|---|---|---|---|---|---|
| Textural Attribute | trol | 1B | 2B | 3B | 4B | 5B | 6B |
| Hardness - Front Teeth | 5.00 | 4.63 | 3.44 | 3.63 | 3.06 | 3.31 | 3.40 |
| Crispness - 1st Bite | 1.81 | 1.86 | 1.73 | 0.94 | 1.19 | 1.38 | 1.80 |
| Toughness | 3.81 | 3.67 | 2.94 | 2.69 | 3.44 | 3.44 | 3.55 |
| Uniformity of Bite | 8.33 | 9.29 | 8.71 | 9.09 | 9.63 | 9.13 | 9.09 |
| Hardness - Molars | 4.81 | 4.64 | 3.14 | 2.69 | 3.31 | 3.69 | 3.19 |
| Crispness - 1st Chew | 2.67 | 2.31 | 1.63 | 1.00 | 1.06 | 2.06 | 1.50 |
| Crispness - 4-5th | 2.67 | 2.25 | 1.88 | 1.18 | 1.25 | 2.25 | 1.80 |
| Chews | | | | | | | |
| Duration of Sound | 4.50 | 3.50 | 3.38 | 3.38 | 3.00 | 4.06 | 3.40 |
| Textural Attribute | 7B | 8B | 9B | 10B | 11B | 12B | 13B |
| Hardness - Front Teeth | 3.31 | 3.29 | 2.25 | 3.45 | 3.40 | 3.30 | 3.94 |
| Crispness - 1st Bite | 1.38 | 2.08 | 1.00 | 1.60 | 1.55 | 1.60 | 1.81 |
| Toughness | 3.63 | 3.51 | 3.25 | 3.50 | 3.65 | 3.75 | 3.56 |
| Uniformity of Bite | 8.75 | 8.66 | 9.44 | 9.41 | 8.55 | 8.95 | 9.00 |
| Hardness - Molars | 3.81 | 3.50 | 3.05 | 3.35 | 3.60 | 3.40 | 3.38 |
| Crispness - 1st Chew | 1.44 | 1.87 | 0.94 | 1.59 | 1.75 | 1.45 | 2.33 |
| Crispness - 4-5th | 1.88 | 1.74 | 1.69 | 1.65 | 1.80 | 1.40 | 2.38 |
| Chews | | | | | | | |
| Duration of Sound | 2.50 | 2.96 | 2.75 | 3.50 | 3.35 | 2.95 | 4.31 |
| Textural Attribute | 14B | 15B | 16B | 17B | 18B | 19B | 20B |
| Hardness - Front Teeth | 3.36 | 3.81 | 3.44 | 4.25 | 2.94 | 3.60 | 3.95 |
| Crispness - 1st Bite | 1.50 | 1.25 | 1.88 | 1.69 | 1.44 | 1.95 | 2.60 |
| Toughness | 3.70 | 3.56 | 3.13 | 3.56 | 3.25 | 3.75 | 4.10 |
| Uniformity of Bite | 8.75 | 8.94 | 8.50 | 8.61 | 9.06 | 8.75 | 8.50 |
| Hardness - Molars | 3.80 | 3.63 | 3.33 | 4.13 | 3.64 | 3.75 | 4.15 |
| Crispness - 1st Chew | 1.65 | 1.54 | 2.06 | 1.63 | 1.99 | 1.95 | 2.75 |
| Crispness - 4-5th | 1.90 | 1.75 | 2.00 | 2.25 | 2.36 | 2.00 | 2.80 |
| Chews | | | | | | | |
| Duration of Sound | 3.50 | 3.31 | 3.81 | 3.01 | 3.50 | 3.20 | 4.50 |

Descriptive analysis revealed significant differences among DOE samples and tapioca dextrin. Samples with higher levels of the commercially available, heat moisture treated, rice flour and the commercially available, thermally inhibited, tapioca starch have more crispness, duration of sound, and uniformity of bite. Samples with moderate levels of the commercially available, heat moisture treated, rice flour and the commercially available, thermally inhibited, tapioca starch indicate less crispness, hardness, and duration of sound.

### Example 3

### Comparisons of a Commercially Available, Heat Moisture Treated, Rice Flour to Native Rice Flour on Crispness Attributes in a Sweet Potato Product Coating

Results of the experimentation conducted in Example 2 indicated that higher levels of a commercially available, heat moisture treated, rice flour in combination with higher levels of the commercially available, thermally inhibited, tapioca starch seems to have more of an impact on crispness. Further experimentation was required to conclusively determine whether the benefits could be solely attributed to the commercially available, heat moisture treated, rice flour, or whether the native rice flour provided the same benefit. Therefore, another six variables within the design of experiments were tested to determine the extent of the benefit.

Sweet potatoes were peeled, pre-heated in water for 30 minutes at 71° C., cut into ⅜ inch strips, and immersed and blanched in hot water for 3 minutes at 88° C. After blanching, the potato strips were immersed for 30 seconds in an aqueous solution comprising 0.75% SAPP which was held at a temperature of 71-77° C. After removal, the strips were drained and then dried in a conventional dryer at 60° C., for a sufficient length of time to produce a 10 to 14 percent water loss.

Enrobing solutions were then prepared comprising the ingredients listed in Table 5 including water. The dry ingredients were combined, added to the water at a 1:1.4 ratio, and well mixed using a KitchenAid® mixer. The sweet potato strips were then dipped in the starch solution. The sweet potato strips were then drained to remove excess solution and to achieve a solution coating pickup about 12-18%, averaging 15%. The strips were then par fried in soybean oil for 60 seconds at 191° C. The strips were then par fried in soybean oil for 60 seconds at 191° C. The sweet potato strips were transferred into plastic trays, frozen in a blast freezer at −29° C. for 1 hour minimum, and stored in a freezer for two weeks at −23° C. before being evaluated by sensory descriptive profiling as in Example 1. See Table 6 for results.

TABLE 5

| Ingredients | 1C | 2C | 3C | 4C | 5C | 6C |
|---|---|---|---|---|---|---|
| a commercially available, | 57.00 | 38.00 | 57.00 | 52.25 | 38.00 | 52.25 |
| thermally inhibited, tapioca | | | | | | |
| starch | | | | | | |
| rice flour | 28.50 | 19.00 | 9.50 | 14.25 | 14.25 | 23.75 |
| an unmodified corn starch | 9.50 | 14.25 | 4.75 | 9.50 | 14.25 | 7.12 |
| containing about 55% amylose | | | | | | |
| salt | 2.92 | 2.92 | 2.92 | 2.92 | 2.92 | 2.92 |
| dextrose | 0.98 | 0.98 | 0.98 | 0.98 | 0.98 | 0.98 |
| sodium bicarbonate | 0.98 | 0.98 | 0.98 | 0.98 | 0.98 | 0.98 |
| xanthan gum | 0.12 | 0.12 | 0.12 | 0.12 | 0.12 | 0.12 |
| turmeric and oleoresin paprika | <0.10 | <0.10 | <0.10 | <0.10 | <0.10 | <0.10 |
| a commercially available, heat | 0.00 | 23.75 | 23.75 | 19.00 | 28.50 | 11.88 |
| moisture treated, rice flour | | | | | | |
| total | 100.00 | 100.00 | 100.00 | 100.00 | 100.00 | 100.00 |

TABLE 6

| Textural Attribute | 1C | 2C | 3C | 4C | 5C | 6C |
|---|---|---|---|---|---|---|
| Hardness - Front Teeth | 3.39 | 3.57 | 3.94 | 4.06 | 3.72 | 4.44 |
| Crispness - 1st Bite | 1.39 | 1.50 | 2.06 | 2.17 | 3.78 | 0.93 |
| Toughness | 3.06 | 2.67 | 2.89 | 2.89 | 3.06 | 2.89 |
| Uniformity of Bite | 9.33 | 9.11 | 8.83 | 9.21 | 8.94 | 9.93 |
| Hardness - Molars | 3.72 | 3.83 | 3.78 | 3.90 | 4.00 | 3.94 |
| Crispness - 1st Chew | 1.56 | 1.28 | 2.17 | 2.50 | 1.72 | 1.16 |
| Crispness - 4-5th Chews | 1.78 | 1.33 | 2.06 | 2.06 | 1.72 | 0.94 |
| Duration of Sound | 3.11 | 2.64 | 3.72 | 3.44 | 3.00 | 1.44 |

Descriptive analysis revealed significant differences among products in crispness in the samples. Samples with high levels of a commercially available, heat moisture treated, rice flour and a commercially available, thermally inhibited, tapioca starch have more of an impact on crispness and duration of sound. Samples with high levels of native rice flour exhibited less crispness.

### Example 4

### Comparisons of Commercially Available, Heat Moisture Treated, Rice Flour, and Commercially Available, Thermally Inhibited, Waxy Rice Starch Enrobing Solutions at Identified Optimal Usage Levels Compared to the Tapioca Dextrin in the Sweet Potato Product Coating

Results of the experimentation conducted in Example 3 indicated that higher levels of a commercially available, heat moisture treated, rice flour in combination with higher levels of a commercially available, thermally inhibited, tapioca starch provided improved crispness over native rice flour. It was desired to test these six variables in combination with variables that exhibited higher levels of crispness from previous work and new compositions based on key findings from the work outlined in this application. These included compositions that utilized a commercially available thermally inhibited waxy rice starch. Also included were compositions that utilized another commercially available, thermally inhibited, tapioca starch to replace the primary ungelatinized starch component. Eighteen variables were produced and evaluated by a group of key project team members. The six best performing variables (1D, 2D, 3D, 4D, 5D, 6D), and 7D (control) with tapioca dextrin were evaluated by a trained sensory panel.

Sweet potatoes were peeled, pre-heated in water for 30 minutes at 71° C., cut into ⅜ inch strips, and immersed and blanched in hot water for 3 minutes at 88° C. After blanching, the potato strips were immersed for 30 seconds in an aqueous solution comprising 0.75% SAPP which was held at a temperature of 71-77° C. After removal, the strips were drained and then dried in a conventional dryer at 60° C., for a sufficient length of time to produce a 10 to 14 percent water loss.

Enrobing solutions were then prepared comprising the ingredients listed in Table 7 including water. The dry ingredients and then added to the water at a 1:1.4 ratio and well mixed using a KitchenAid® mixer. The sweet potato strips were then dipped in the starch solution. The sweet potato strips were then drained to remove excess solution and to achieve a solution coating pickup about 12-18%, averaging 15%. The strips were then par fried in soybean oil for 60 seconds at 191° C. The strips were then par fried in soybean oil for 60 seconds at 191° C. The sweet potato strips were transferred into plastic trays, frozen in a blast freezer at −29° C. for 1 hour minimum, and stored in a freezer for two weeks at −23° C. before being evaluated by sensory descriptive profiling as in Example 1. See Table 8 for results.

TABLE 7

| Ingredients | 1D | 2D | 3D | 4D | 5D | 6D | 7D |
|---|---|---|---|---|---|---|---|
| a commercially available, thermally | 38.00 | 33.25 | 0.00 | 0.00 | 52.25 | 38.00 | 53.00 |
| inhibited, tapioca starch | | | | | | | |
| another thermally inhibited, tapioca | 0.00 | 0.00 | 28.50 | 28.50 | 0.00 | 0.00 | 0.00 |
| starch | | | | | | | |
| rice flour | 19.00 | 19.00 | 28.50 | 28.50 | 23.75 | 16.63 | 24.88 |
| an unmodified corn starch | 14.25 | 9.50 | 14.25 | 0.00 | 7.12 | 14.25 | 7.00 |
| containing about 55% amylose | | | | | | | |
| an unmodified corn starch | 0.00 | 0.00 | 0.00 | 14.25 | 0.00 | 0.00 | 0.00 |
| containing about 70% amylose | | | | | | | |
| salt | 2.92 | 2.92 | 2.92 | 2.92 | 2.92 | 2.92 | 3.00 |
| dextrose | 0.98 | 0.98 | 0.98 | 0.98 | 0.98 | 0.98 | 1.00 |
| sodium bicarbonate | 0.98 | 0.98 | 0.98 | 0.98 | 0.98 | 0.98 | 1.00 |
| xanthan gum | 0.12 | 0.12 | 0.12 | 0.12 | 0.12 | 0.12 | 0.12 |
| turmeric and oleoresin paprika | <0.10 | <0.10 | <0.10 | <0.10 | <0.10 | <0.10 | <0.10 |
| a commercially available, heat | 23.75 | 33.25 | 23.75 | 23.75 | 0.00 | 26.12 | 0.00 |
| moisture treated, rice flour | | | | | | | |
| a commercially available, thermally | 0.00 | 0.00 | 0.00 | 0.00 | 11.88 | 0.00 | 0.00 |
| inhibited, waxy rice starch | | | | | | | |
| a commercially available, tapioca | 0.00 | 0.00 | 0.00 | 0.00 | 0.00 | 0.00 | 10.00 |
| dextrin | | | | | | | |
| total | 100.00 | 100.00 | 100.00 | 100.00 | 100.00 | 100.00 | 100.00 |

TABLE 8

| | | | | | | | 7D |
|---|---|---|---|---|---|---|---|
| Textural Attribute | 1D | 2D | 3D | 4D | 5D | 6D | Control |
| Hardness - Front | 4.33 | 4.53 | 4.63 | 4.43 | 4.77 | 4.84 | 4.87 |
| Teeth | | | | | | | |
| Crispness - 1st Bite | 2.96 | 2.57 | 2.90 | 2.63 | 2.97 | 2.59 | 2.85 |
| Toughness | 3.57 | 3.40 | 3.43 | 3.30 | 3.67 | 3.47 | 3.53 |
| Uniformity of Bite | 8.50 | 8.37 | 8.70 | 8.30 | 8.41 | 8.69 | 8.61 |
| Hardness - Molars | 4.57 | 4.62 | 4.50 | 4.63 | 4.56 | 4.44 | 4.67 |
| Crispness - 1st | 2.83 | 2.49 | 2.85 | 2.70 | 2.93 | 2.80 | 2.87 |
| Chew | | | | | | | |
| Crispness - 4-5th | 2.89 | 2.80 | 2.96 | 2.77 | 3.13 | 2.86 | 3.10 |
| Chews | | | | | | | |
| Duration of Sound | 4.23 | 4.00 | 4.17 | 4.06 | 4.07 | 3.79 | 4.13 |

All prototype compositions performed similarly to each other. The data suggests the following trend from most to least crisp: 5D, 7D (control), 3D, 1D, 6D, 4D, and 2D. Therefore, it can be concluded that overall 3D and 5D are the closest matches to 7D (control) with dextrin. The results show that even in the absence of dextrin as a crisping agent that crispness was comparable between the samples.

### Example 5

### Sensory Evaluation of Commercially Available, Heat Moisture Treated, Rice Flour, Low Protein, Heat Moisture Treated, Rice Flour, Native Rice Flour, Commercially Available, Heat Moisture Treated, Waxy Wheat Flour, Commercially Available, Thermally Inhibited, Waxy Rice Starch (Medium Inhibition), Commercially Available, Thermally Inhibited, Waxy Rice Starch (High Inhibition), Native Rice Starch, Thermally Inhibited Sorghum Flour (Medium Inhibition), Thermally Inhibited Sorghum Flour (High Inhibition), and Native Sorghum Flour—Containing Enrobing Solutions at Identified Optimal Usage Levels Compared to the Tapioca Dextrin in the Sweet Potato Product Coating

Results of the experimentation conducted in Example 4 indicated that following the prescribed compositions highlighted in this application disclosure led to the development of compositions which were equivalent in crispness to an identified typical recipe with dextrin. Use of high levels of a commercially available, heat moisture treated, rice flour in combination with high levels of commercially available, thermally inhibited, tapioca starch provided comparable crispness to a control composition with tapioca dextrin. Use of a commercially available, thermally inhibited, waxy rice starch also produced similar crispness results as compared to tapioca dextrin. Previous screening work indicated thermally inhibited sorghum flour and heat moisture treated waxy wheat flour showed promise as providing a similar crispness benefit. A set of variables was identified to compare the crispness benefits of the heat moisture treated rice flour; heat moisture treated waxy wheat flour, thermally inhibited waxy rice starch, and thermally inhibited sorghum flour. In addition to baking, it was desired to evaluate the impact of rethermalizing the sweet potato fries by frying on crispness.

Sweet potatoes were peeled, pre-heated in water for 30 minutes at 71° C., cut into ⅜ inch strips, and immersed and blanched in hot water for 3 minutes at 88° C. After blanching, the potato strips were immersed for 30 seconds in an aqueous solution comprising 0.75% SAPP which was held at a temperature of 71-77° C. After removal, the strips were drained and then dried in a conventional dryer at 60° C., for a sufficient length of time to produce a 10 to 14 percent water loss.

Enrobing solutions were then prepared comprising the ingredients listed in Table 9 including water. The dry ingredients and then added to the water at a 1:1.4 ratio and well mixed using a KitchenAid® mixer. The sweet potato strips were then dipped in the starch solution. The sweet potato strips were then drained to remove excess solution and to achieve a solution coating pickup about 12-18%, averaging 15%. The strips were then par fried in soybean oil for 60 seconds at 191° C. The sweet potato strips were transferred into plastic trays, frozen in a blast freezer at −29° C. for 1 hour minimum, and stored in a freezer for two weeks at −23° C. before being evaluated by a team of researchers for crispness. See Table 10 for results.

TABLE 9

| ingredients | |
|---|---|
| a commercially available, thermally | 38.00 |
| inhibited, tapioca starch | |
| rice flour | 19.00 |
| an unmodified corn starch containing | 14.25 |
| about 55% amylose | |
| salt | 2.92 |
| dextrose | 0.98 |
| sodium bicarbonate | 0.98 |
| xanthan gum | 0.12 |
| turmeric and oleoresin paprika | <0.10 |
| test starch or flour | 23.75 |
| total | 100.00 |

TABLE 10

| | | Crispness, | Crispness, |
|---|---|---|---|
| DESCRIPTION | Variable | Baked* | Fried** |
| tapioca dextrin | 1E | 4.00 | 5.00 |
| a commercially available, | 2E | 3.50 | 4.50 |
| heat moisture treated | | | |
| rice flour | | | |
| a low protein, heat moisture | 3E | 4.00 | 5.00 |
| treated rice flour | | | |
| native rice flour | 4E | 2.50 | 2.50 |
| a commercially available, | 5E | 4.00 | 5.00 |
| heat moisture treated | | | |
| waxy wheat flour | | | |
| a commercially available, | 6E | 4.00 | 4.50 |
| thermally inhibited waxy | | | |
| rice starch (medium | | | |
| inhibition) | | | |
| a commercially available, | 7E | 3.50 | 4.00 |
| thermally inhibited waxy | | | |
| rice starch (high | | | |
| inhibition) | | | |
| native rice starch | 8E | 2.50 | 3.00 |
| a thermally inhibited, | 9E | 3.00 | 3.50 |
| sorghum flour | | | |
| (medium inhibition) | | | |
| a thermally inhibited, | 10E | 3.50 | 4.50 |
| sorghum flour | | | |
| (high inhibition) | | | |
| native sorghum flour | 11E | 2.50 | 2.50 |
| RATING | Scale for | 1 = Not Crisp | 1 = Not Crisp |
| | Attributes | 6 = Very Crisp | 6 = Very Crisp |

*Baked - 22 minutes at 204° C.
**Fried - 2.5 minutes at 182° C.

For this example, an informal evaluation was performed by an experienced group of individuals. Frozen sweet potato fry samples were portioned out in batches prior to baking or frying. Samples were baked on sheet pans for 22 minutes in pre-heated 204° C. ovens or fried for 2.5 minutes at 182° C. The samples were rated on a scale of 1 to 6; 1=not crisp to 6=very crisp.

Informal evaluation of starches and flours used to replace tapioca dextrin in a coating composition showed that there were several that exhibited similar textural attributes in this specific recipe for sweet potato fry coating. The commercially available, heat moisture treated, rice flour and the commercially available, low protein, rice flour were similar in crispness to tapioca dextrin after baking or frying. Native rice flour was not as crisp as the commercially available, heat moisture treated, rice flour, or the low protein, rice flour after baking or frying. Heat moisture treated waxy wheat flour was similar in crispness as compared to tapioca dextrin after baking or frying. It should be noted that pickup was higher due to higher viscosity of the enrobing solution with heat moisture treated wheat flour. The commercially available, thermally inhibited, waxy rice starch (medium inhibition) was similar in crispness to tapioca dextrin after baking and frying. The other commercially available, thermally inhibited, waxy rice starch (high inhibition) was tougher and therefore not as crisp after baking and frying. Native rice flour was not as crisp thermally inhibited waxy rice starch with a medium or high inhibition level after baking or frying. Thermally inhibited sorghum flour with a high inhibition level was similar in crispness to tapioca dextrin after baking or frying. Thermally inhibited sorghum flour with a medium inhibition level was not as crisp. Native sorghum flour was not as crisp as thermally inhibited sorghum flour with a medium or high inhibition level after baking or frying. Overall, it was discovered that several heat moisture treated or thermally inhibited starches and flours exhibited similar crispness properties to tapioca dextrin in a sweet potato fry coating.

After receiving the results of the experimentation in Example 5, it was desired to expand the use of the coating containing heat moisture treated and thermally inhibited starches and flours to a potato fry product where commercial opportunities for application would be greater.

### Example 6

### Sensory Evaluation of a Commercially Available, Heat Moisture Treated Rice Flour, a Commercially Available Thermally Inhibited Waxy Rice Starch (Medium Inhibition), and a Commercially Available Thermally Inhibited Tapioca Starch (High Inhibition Level) and their Chemically Modified and Native Counterparts Compared to the Tapioca Dextrin in a Potato Product Coating

Results of the experimentation conducted in Examples 1-5 indicated that following the prescribed compositions highlighted in this application disclosure led to the development of compositions which were equivalent in crispness to an identified typical recipe with dextrin. Use of high levels of a commercially available, heat moisture treated, rice flour in combination with high levels of a commercially available, thermally inhibited, tapioca starch provided comparable crispness to a control composition with tapioca dextrin. Use of a commercially available, thermally inhibited, waxy rice starch also produced similar crispness results as compared to tapioca dextrin. Thermally inhibited tapioca starch did not exhibit the same benefit in promoting crispness as compared to tapioca dextrin on sweet potato fries. It was desired to expand the usage of the coating to potato fries which is a much higher volume opportunity for this coating. A set of variables was identified to compare the crispness benefits of the heat moisture treated rice flour and thermally inhibited waxy rice starch to thermally inhibited tapioca starch in a potato product coating, in order to validate earlier findings. In addition, it was determined that the crispness attributes of these products should be compared to their chemically modified and native starch counterparts to determine their effectiveness in optimizing crispness. In addition to baking, it was desired to evaluate the impact of rethermalizing the potato fries by frying on crispness.

Potatoes were cut into ⅜ inch strips, and immersed and blanched in hot water for 11 minutes at 71° C. After removal, the strips were drained and then dried in a conventional dryer at 60° C., for a sufficient length of time to produce a 13 to 16 percent water loss.

Enrobing solutions were then prepared comprising the ingredients listed in Table 11 including water. The dry ingredients and then added to the water at a 1:1.4 ratio and well mixed using a KitchenAid® mixer. The potato strips were then dipped in the starch solution. The potato strips were then drained to remove excess solution and to achieve a solution coating pickup about 12-18%, averaging 15%. The strips were then par fried in soybean oil for 60 seconds at 191° C. The potato strips were transferred into plastic trays, frozen in a blast freezer at −29° C. for 1 hour minimum, and stored in a freezer for two weeks at −23° C. before being evaluated by a team of researchers for crispness. See Table 12 for results.

TABLE 11

| ingredients | |
|---|---|
| a commercially available, thermally | 38.00 |
| inhibited, tapioca starch | |
| rice flour | 19.00 |
| an unmodified corn starch | 14.25 |
| containing about 55% amylose | |
| salt | 2.92 |
| dextrose | 0.98 |
| sodium bicarbonate | 0.98 |
| xanthan gum | 0.12 |
| turmeric and oleoresin paprika | <0.10 |
| test starch or flour | 23.75 |
| total | 100.00 |

TABLE 12

| | | Crispness, | Crispness, |
|---|---|---|---|
| DESCRIPTION | Variable # | Baked* | Fried** |
| a commercially available | 1F | 4.00 | 4.50 |
| tapioca dextrin | | | |
| commercially available, | 2F | 4.00 | 5.00 |
| heat moisture treated rice | | | |
| flour | | | |
| native rice flour | 3F | 2.50 | 2.00 |
| commercially available, | 4F | 4.50 | 5.00 |
| thermally inhibited | | | |
| waxy rice starch | | | |
| (medium inhibition) | | | |
| chemically modified waxy | 5F | 3.00 | 3.50 |
| rice starch | | | |
| native waxy rice starch | 6F | 3.00 | 3.00 |
| commercially available, | 7F | 3.50 | 3.50 |
| thermally inhibited | | | |
| tapioca starch (high | | | |
| inhibition level) | | | |
| chemically modified | 8F | 4.00 | 3.00 |
| tapioca starch | | | |
| native tapioca starch | 9F | 4.00 | 2.50 |
| RATING | Scale for | 1 = Not Crisp | 1 = Not Crisp |
| | Attributes | 6 = Very Crisp | 6 = Very Crisp |

*Baked - 22 minutes at 204° C.
**Fried - 2.5 minutes at 182° C.

For this example, an informal evaluation was performed by an experienced group of individuals. Frozen potato fry samples were portioned out in batches prior to baking or frying. Samples were baked on sheet pans for 22 minutes in pre-heated 204° C. ovens or fried for 2.5 minutes at 182° C. The samples were rated on a scale of 1 to 6, 1=not crisp to 6=very crisp.

Informal evaluation of starches and flours used to replace tapioca dextrin in a coating composition showed that there were several that exhibited similar textural attributes in this specific recipe for potato fry coating. The commercially available, heat moisture treated, rice flour was similar in crispness to tapioca dextrin after baking or frying. Native rice flour was not as crisp as the commercially available, heat moisture treated, rice flour after baking or frying. The commercially available, thermally inhibited, waxy rice starch (medium inhibition level) was similar in crispness to tapioca dextrin after baking or frying. The thermally inhibited, waxy rice starch (medium inhibition level) was better than both the chemically modified equivalent and the native waxy rice starch. Thermally inhibited tapioca starch with a high inhibition level was similar in crispness to tapioca dextrin after baking but not frying. Chemically modified tapioca starch and native tapioca starch were equivalent in crispness as compared to thermally inhibited tapioca starch with a high inhibition level after baking but slightly lower after frying. It was concluded that the thermal inhibition of tapioca starch did not result in an unexpected benefit as compared to chemically modified or native tapioca starch. In addition, it did not provide the same crispness benefit as compared to heat moisture treated rice flour or thermally inhibited waxy rice starch, especially after being reconstituted by frying. Therefore, thermally inhibited tapioca starch is not recommended as a replacement for dextrin in this patent application. In conclusion, it was discovered that heat moisture treated rice flour and thermally inhibited waxy rice starch exhibited similar crispness properties to tapioca dextrin in a potato fry coating.

### Example 7

### Sensory Evaluation of a Commercially Available, Heat Moisture Treated Rice Flour, Heat Moisture Treated, Low Protein, Rice Flour, Commercially Available, Thermally Inhibited Waxy Rice Starch (Medium Inhibition), Commercially Available, Thermally Inhibited Waxy Rice Starch (High Inhibition), Thermally-Inhibited Sorghum Flour (Medium Inhibition), Thermally Inhibited Sorghum Flour (High Inhibition), Commercially Available, Heat Moisture Treated, Waxy Wheat Flour, Thermally Inhibited Waxy Wheat Flour (Medium Inhibition), and Thermally Inhibited Waxy Wheat Flour (High Inhibition)—Containing Enrobing Solutions at Identified Optimal Usage Levels Compared to the Tapioca Dextrin in a Potato Product Coating

Results of the experimentation conducted in Example 5 indicated that following the prescribed compositions highlighted in this application disclosure led to the development of compositions which were equivalent in crispness to an identified typical recipe with dextrin in a potato product coating. Previous screening work indicated thermally inhibited sorghum flour, a heat moisture treated waxy wheat flour and a thermally inhibited waxy wheat flour showed promise as providing a similar crispness benefit. A set of variables was identified to compare the crispness benefits of the heat moisture treated rice flour, waxy rice starch, sorghum flour, and waxy wheat flour in a potato product coating.

Potatoes were cut into ⅜ inch strips, and immersed and blanched in hot water for 11 minutes at 71° C. After removal, the strips were drained and then dried in a conventional dryer at 60° C., for a sufficient length of time to produce a 13 to 16 percent water loss.

Enrobing solutions were then prepared comprising the ingredients listed in Table 13 including water. The dry ingredients and then added to the water at a 1:1.4 ratio and well mixed using a KitchenAid® mixer. The potato strips were then dipped in the starch solution. The potato strips were then drained to remove excess solution and to achieve a solution coating pickup about 12-18%, averaging 15%. The strips were then par fried in soybean oil for 60 seconds at 191° C. The potato strips were transferred into plastic trays, frozen in a blast freezer at −29° C. for 1 hour minimum, and stored in a freezer for two weeks at −23° C. before being evaluated by a team of researchers for crispness. See Table 14 for results.

TABLE 13

| ingredients | |
|---|---|
| a commercially available, thermally | 38.00 |
| inhibited, tapioca starch | |
| rice flour | 19.00 |
| an unmodified corn starch containing | 14.25 |
| about 55% amylose | |
| salt | 2.92 |
| dextrose | 0.98 |
| sodium bicarbonate | 0.98 |
| xanthan gum | 0.12 |
| turmeric and oleoresin paprika | <0.10 |
| test starch or flour | 23.75 |
| total | 100.00 |

TABLE 14

| | | Crispness | Crispness, |
|---|---|---|---|
| DESCRIPTION | Variable | Baked* | Fried** |
| a commercially available, | 1G | 4.50 | 5.00 |
| thermally inhibited | | | |
| waxy rice starch | | | |
| (medium inhibition) | | | |
| a commercially available, | 2G | 3.50 | 4.50 |
| thermally inhibited | | | |
| waxy rice starch (high | | | |
| inhibition) | | | |
| native waxy rice starch | 3G | 2.50 | 3.00 |
| a commercially available, | 4G | 4.00 | 4.50 |
| heat moisture treated | | | |
| rice flour | | | |
| a low protein, heat moisture | 5G | 3.50 | 4.00 |
| treated rice flour | | | |
| native rice flour | 6G | 2.25 | 2.75 |
| a commercially available, | 7G | 4.50 | 5.50 |
| heat moisture treated | | | |
| waxy wheat flour | | | |
| a thermally inhibited, | 8G | 3.50 | 4.50 |
| waxy wheat flour | | | |
| (medium inhibition) | | | |
| a thermally inhibited, | 9G | 4.25 | 5.50 |
| waxy wheat flour (high | | | |
| inhibition) | | | |
| native waxy wheat flour | 10G | 2.50 | 3.75 |
| a thermally inhibited, | 11G | 3.00 | 3.50 |
| sorghum flour (medium | | | |
| inhibition) | | | |
| a thermally inhibited, | 12G | 3.50 | 4.50 |
| sorghum flour (high | | | |
| inhibition) | | | |
| native sorghum flour | 13G | 2.50 | 2.50 |
| a commercially available | 14G | 4.50 | 5.00 |
| tapioca dextrin | | | |
| RATING | Scale for | 1 = Not Crisp | 1 = Not Crisp |
| | Attributes | 6 = Very Crisp | 6 = Very Crisp |

*Baked - 22 minutes at 204° C.
**Fried - 2.5 minutes at 182° C.

For this example, an informal evaluation was performed by an experienced group of individuals. Frozen potato fry samples were portioned out in batches prior to baking or frying. Samples were baked on sheet pans for 22 minutes in pre-heated 204° C. ovens or fried for 2.5 minutes at 182° C. The samples were rated on a scale of 1 to 6; 1=not crisp to 6=very crisp.

Informal evaluation of starches and flours used to replace tapioca dextrin in a coating composition showed that there were several that exhibited similar textural attributes in this specific recipe for potato fry coating. The commercially available, heat moisture treated, rice flour and a low protein, heat moisture treated, rice flour were similar in crispness to tapioca dextrin after baking or frying. Native rice flour was not as crisp as the commercially available, heat moisture treated, rice flour, or the low protein, heat moisture treated, rice flour after baking or frying. The commercially available, thermally inhibited, waxy rice starch (medium inhibition level) was similar in crispness to tapioca dextrin after frying. The other commercially available, thermally inhibited, waxy rice starch (high inhibition level) was similar in crispness after frying but was tougher and therefore not as crisp after baking. Thermally inhibited sorghum flour with a high inhibition level was similar in crispness to tapioca dextrin after baking or frying. Thermally inhibited sorghum flour with a medium inhibition level was not as crisp. Native sorghum flour was not as crisp as thermally inhibited sorghum flour with a medium or high inhibition level after baking or frying. Heat moisture treated waxy wheat flour and thermally inhibited waxy wheat flour with a high inhibition level were similar in crispness as compared to tapioca dextrin after baking or frying. Thermally inhibited waxy wheat flour with a medium inhibition level was not as crisp. Native waxy wheat flour was not as crisp as the heated moisture treated or thermally inhibited wheat flour samples. It should be noted that pickup was higher due to higher viscosity of the enrobing solution on all the wheat flour samples. Overall, it was discovered that several heat moisture treated or thermally inhibited starches and flours exhibited similar crispness properties to tapioca dextrin in a potato fry coating.

Throughout this application, various publications are referenced. The disclosures of these publications in their entireties are hereby incorporated by reference into this application in order to more fully describe the state of the art as known to those skilled therein as of the date of the application described and claimed herein.

While particular embodiments of the present application have been illustrated and described, it would be obvious to those skilled in the art that various other changes and modifications can be made without departing from the spirit and scope of the application. It is therefore intended to cover in the appended claims all such changes and modifications that are within the scope of this application.

1. A composition comprising separately by weight:
a) from about 20% to about 70% of non-gelatinized tapioca starch,
b) from about 15% to about 30% of rice flour,
c) from about 5% to about 30% of high amylose corn starch, and
d) from about 5% to about 40% of flour or starch, which has been heat moisture treated or thermally inhibited.

2. The composition of claim 1, wherein the amount by weight of non-gelatinized tapioca starch is from about 30% to about 50%.

3. The composition of claim 2, wherein the amount by weight of non-gelatinized tapioca starch is from about 35% to about 40%.

4. (canceled)

5. The composition of claim 1, wherein the amount by weight of rice flour is from about 18% to about 24%.

6. The composition of claim 1, wherein the amount by weight of high amylose corn starch is from about 9% to about 24%.

7. The composition of claim 6, wherein the amount by weight of high amylose corn starch is from about 12% to about 17%.

8. The composition of claim 1, wherein the amount by weight of flour or starch, which has been heat moisture treated or thermally inhibited is from about 10% to about 35%.

9. The composition of claim 8, wherein the amount by weight of flour or starch, which has been heat moisture treated or thermally inhibited is from about 20% to about 25%.

10. The composition of claim 1, wherein the amount by weight of non-gelatinized tapioca starch is from about 35% to about 40%, the amount by weight of rice flour is from about 18% to about 24%, the amount by weight of high amylose corn starch is from about 12% to about 17%, and the amount by weight of flour or starch, which has been heat moisture treated or thermally inhibited is from about 20% to about 25%.

11. (canceled)

12. (canceled)

13. The composition of claim 1, wherein the flour or starch, which has been heat moisture treated or thermally inhibited is heat moisture treated rice flour, thermally inhibited waxy rice starch, thermally inhibited sorghum flour, heat moisture treated or thermally inhibited waxy wheat flour, or any mixtures thereof.

14. An enrobing solution comprising one part by weight of a composition of claim 1 and from about one part to about two parts by weight of water.

15. The enrobing solution of claim 14 comprising from about 1.2 parts to about 1.6 parts by weight of water.

16. An enrobed food prepared with the enrobing solution of claim 14 and a food.

17. The enrobed food of claim 16, wherein the food comprises potato.

18. The enrobed food of claim 17, wherein the enrobed food comprises sweet potato.

19. The enrobed food of claim 16, wherein the enrobed food is then par fried.

20. The enrobed food of claim 16, wherein the enrobed food is then frozen.

21. The enrobed food of claim 16, wherein the enrobed food is then baked.

22. The enrobed food of claim 16, wherein the enrobed food is then, in any sequence, par fried, frozen, and baked.

23. The composition of claim 1, wherein the composition is dextrin free.
